(19) United States
(12) Patent Application Publication
(10) Pub. No.: US 2007/0154709 A1
(43) Pub. Date: Jul. 5, 2007

(54) Nanoparticles

(76) Inventors: Matthias Koch, Wiesbaden (DE); Victor Khrenov, Wiesbaden (RU); Markus Klapper, Mainz (DE); Klaus Muellen, Koeln (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 10/587,299

(22) PCT Filed: Dec. 15, 2004
(86) PCT No.: PCT/EP04/14283

§ 371 Date: Jul. 26, 2006

(30) Foreign Application Priority Data
Jan. 27, 2004 (DE) 10 2004 004 210.1
Sep. 28, 2004 (EP) 04023003.9

(51) Int. Cl. B32B 15/00

(52) U.S. Cl. 428/379; 977/900; 977/902

(57) ABSTRACT

The invention relates to polymer-modified nanoparticles which are suitable as UV stabilisers in polymers, characterised in that they are obtainable by a process in which, in a step a), an inverse emulsion comprising one or more water-soluble precursors of the nanoparticles or a melt is prepared with the aid of a random copolymer of at least one monomer containing hydrophobic radicals and at least one monomer containing hydrophilic radicals, and, in a step b), particles are produced, and to the use thereof for UV protection in polymers.

The invention relates to polymer-modified nanoparticles, to a process for the production of such particles, and to the use thereof for UV protection in polymers.

The incorporation of inorganic nanoparticles into a polymer matrix can influence not only the mechanical properties, such as, for example, impact strength, of the matrix, but also modifies its optical properties, such as, for example, wavelength-dependent transmission, colour (absorption spectrum) and refractive index. In mixtures for optical applications, the particle size plays an important role since the addition of a substance having a refractive index which differs from the refractive index of the matrix inevitably results in light scattering and ultimately in light opacity. The drop in the intensity of radiation of a defined wavelength on passing through a mixture shows a high dependence on the diameter of the inorganic particles.

In addition, a very large number of polymers are sensitive to UV radiation, meaning that the polymers have to be UV-stabilised for practical use. Many organic UV filters which would in principle be suitable here as stabilisers are unfortunately themselves not photostable, and consequently there continues to be a demand for suitable materials for long-term applications.

Suitable substances consequently have to absorb in the UV region, appear as transparent as possible in the visible region and be straight-forward to incorporate into polymers. Although numerous metal oxides absorb UV light, they can, however, for the above-mentioned reasons only be incorporated with difficulty into polymers without impairing the mechanical or optical properties in the region of visible light.

The development of suitable nanomaterials for dispersion in polymers requires not only control of the particle size, but also of the surface properties of the particles. Simple mixing (for example by extrusion) of hydrophilic particles with a hydrophobic polymer matrix results in inhomogeneous distribution of the particles throughout the polymer and additionally in aggregation thereof. For homogeneous incorporation of inorganic particles into polymers, their surface must therefore be at least hydrophobically modified. In addition, the nanoparticulate materials, in particular, exhibit a great tendency to form agglomerates, which also survive subsequent surface treatment.

Surprisingly, it has now been found that nanoparticles can be precipitated from emulsions directly with a suitable surface modification with virtually no agglomerates if certain random copolymers are employed as emulsifier.

The particles obtained in this way are particularly advantageous with respect to incorporation into hydrophobic polymers, since the particles can be distributed homogeneously in the polymer through simple measures and absorb virtually no radiation in the visible region.

The present invention therefore relates firstly to polymer-modified nanoparticles which are suitable as UV stabilisers in polymers, characterised in that they are obtainable by a process in which, in a step a), an inverse emulsion comprising one or more water-soluble precursors of the nanoparticles or a melt is prepared with the aid of a random copolymer of at least one monomer containing hydrophobic radicals and at least one monomer containing hydrophilic radicals, and, in a step b), particles are produced.

The present invention furthermore relates to a process for the production of polymer-modified nanoparticles which is characterised in that, in a step a), an inverse emulsion comprising one or more water-soluble precursors of the nanoparticles or a melt is prepared with the aid of a random copolymer of at least one monomer containing hydrophobic radicals and at least one monomer containing hydrophilic radicals, and, in a step b), particles are produced.

The emulsion technique for the production of nanoparticles is known in principle. Thus, M. P. Pileni; J. Phys. Chem. 1993, 97, 6961-6973, describes the production of semiconductor particles, such as CdSe, CdTe and ZnS, in inverse emulsion.

However, the syntheses of the inorganic materials frequently require high salt concentrations of precursor materials in the emulsion, while the concentration additionally varies during the reaction. Low-molecular-weight surfactants react to such high salt concentrations, and consequently the stability of the emulsions is at risk (Paul Kent and Brian R. Saunders; Journal of Colloid and Interface Science 242, 437-442 (2001)). In particular, the particle sizes can only be controlled to a limited extent (M.-H. Lee, C. Y. Tai, C. H. Lu, Korean J. Chem. Eng. 16, 1999, 818-822).

K. Landfester (Adv. Mater. 2001, 13, No. 10, 765-768) proposes the use of high-molecular-weight surfactants (PEO-PS block copolymers) in combination with ultrasound for the production of nanoparticles in the particle size range from about 150 to about 300 nm from metal salts.

The choice of random copolymers of at least one monomer containing hydrophobic radicals and at least one monomer containing hydrophilic radicals has now enabled the provision of emulsifiers which facilitate the production of inorganic nanoparticles from inverse emulsions with control of the particle size and particle-size distribution. At the same time, the use of these novel emulsifiers enables the nanoparticles to be isolated from the dispersions with virtually no agglomerates since the individual particles form directly with polymer coatings.

In addition, the nanoparticles obtainable by this method can be dispersed particularly simply and uniformly in polymers, with, in particular, it being possible substantially to avoid undesired impairment of the transparency of such polymers in visible light.

The random copolymers preferably to be employed in accordance with the invention exhibit a weight ratio of structural units containing hydrophobic radicals to structural units containing hydrophilic radicals in the random copolymers which is in the range from 1:2 to 500:1, preferably in the range from 1:1 to 100:1 and particularly preferably in the range from 7:3 to 10:1. The weight average molecular weight of the random copolymers is usually in the range from M_{w}=1000 to 1,000,000 g/mol, preferably in the range from 1500 to 100,000 g/mol and particularly preferably in the range from 2000 to 40,000 g/mol.

It has been found here that, in particular, copolymers which conform to the formula I 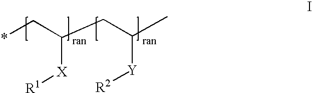
where

X and Y correspond to the radicals of conventional nonionic or ionic monomers, and

R¹ stands for hydrogen or a hydrophobic side group, preferably selected from branched or unbranched alkyl radicals having at least 4 carbon atoms, in which one or more, preferably all, H atoms may have been replaced by fluorine atoms, and

R² stands for a hydrophilic side group, which preferably has a phosphonate, sulfonate, polyol or polyether radical,

and where —X—R¹ and —Y—R² may each have a plurality of different meanings which satisfy the requirements according to the invention in a particular manner within a molecule.

Particular preference is given in accordance with the invention to polymers in which —Y—R² stands for a betaine structure.

Particular preference is in turn given here to polymers of the formula I in which X and Y, independently of one another, stand for —O—, —C(═O)—O—, —C(═O)—NH—, —(CH₂)ₙ—, phenylene or pyridyl. Furthermore, polymers in which at least one structural unit contains at least one quaternary nitrogen atom, where R² preferably stands for a —(CH₂)ₘ—(N⁺(CH₃)₂)—(CH₂)ₙ—SO₃⁻ side group or a —(CH₂)ₘ—(N⁺(CH₃)₂)—(CH₂)ₙ—PO₃²⁻ side group, where m stands for an integer from the range from 1 to 30, preferably from the range from 1 to 6, particularly preferably 2, and n stands for an integer from the range from 1 to 30, preferably from the range from 1 to 8, particularly preferably 3, can advantageously be employed.

Random copolymers particularly preferably to be employed can be prepared in accordance with the following scheme:

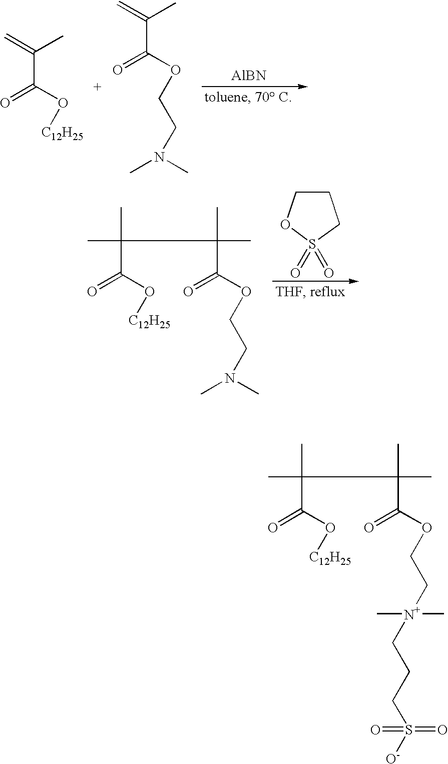

The desired amounts of lauryl methacrylate (LMA) and dimethylaminoethyl methacrylate (DMAEMA) are copolymerised here by known processes, preferably by means of free radicals in toluene through addition of AIBN. A betaine structure is subsequently obtained by known methods by reaction of the amine with 1,3-propane sultone.

Alternative copolymers preferably to be employed can contain styrene, vinylpyrrolidone, vinylpyridine, halogenated styrene or methoxystyrene, where these examples do not represent a limitation. In another, likewise preferred embodiment of the present invention, use is made of polymers which are characterised in that at least one structural unit is an oligomer or polymer, preferably a macromonomer, where polyethers, polyolefins and polyacrylates are particularly preferred as macromonomers.

Suitable precursors for the inorganic nanoparticles are water-soluble metal compounds, preferably silicon, cerium, cobalt, chromium, nickel, zinc, titanium, iron, yttrium and/or zirconium compounds, where these precursors are preferably reacted with an acid or lye for the production of corresponding metal-oxide particles. Mixed oxides can be obtained in a simple manner here by suitable mixing of the corresponding precursors. The choice of suitable precursors presents the person skilled in the art with no difficulties; suitable compounds are all those which are suitable for the precipitation of the corresponding target compounds from aqueous solution. An overview of suitable precursors for the preparation of oxides is given, for example, in Table 6 in K. Osseo-Asare “Microemulsion-mediated Synthesis of nanosize Oxide Materials” in: Kumar P., Mittal K L, (editors), Handbook of microemulsion science and technology, New York: Marcel Dekker, Inc., pp. 559-573, the contents of which expressly belong to the disclosure content of the present application.

Hydrophilic melts can likewise serve as precursors of nanoparticles in the sense of this invention. A chemical reaction for the production of the nanoparticles is not absolutely necessary in this case.

Preferably produced nanoparticles are those which essentially consist of oxides or hydroxides of silicon, cerium, cobalt, chromium, nickel, zinc, titanium, iron, yttrium and/or zirconium.

The particles preferably have a mean particle size, determined by means of a Malvern ZETASIZER (dynamic light scattering) or transmission electron microscope, of from 3 to 200 nm, in particular from 20 to 80 nm and very particularly preferably from 30 to 50 nm. In specific, likewise preferred embodiments of the present invention, the distribution of the particle sizes is narrow, i.e. the variation latitude is less than 100% of the mean, particularly preferably a maximum of 50% of the mean.

In the context of the use of these nanoparticles for UV protection in polymers, it is particularly preferred if the nanoparticles have an absorption maximum in the range 300-500 nm, preferably in the range up to 400 nm, where particularly preferred nanoparticles absorb radiation, in particular, in the UV-A region.

The emulsion process can be carried out here in various ways:

As already stated, particles are usually produced in step b) by reaction of the precursors or by cooling of the melt. The precursors can be reacted here, depending on the process variant selected, with an acid, a lye, a reducing agent or an oxidant.

For the production of particles in the desired particle-size range, it is particularly advantageous if the droplet size in the emulsion is in the range from 5 to 500 nm, preferably in the range from 10 to 200 nm. The droplet size in the given system is set here in the manner known to the person skilled in the art, where the oil phase is matched individually to the reaction system by the person skilled in the art. For the production of ZnO particles, toluene and cyclohexane, for example, have proven successful as the oil phase.

In certain cases, it may be helpful to employ a further coemulsifier, preferably a nonionic surfactant, in addition to the random copolymer. Preferred coemulsifiers are optionally ethoxylated or propoxylated, relatively long-chain alkanols or alkylphenols having various degrees of ethoxylation or propoxylation (for example adducts with from 0 to 50 mol of alkylene oxide).

It may also be advantageous to employ dispersion aids, preferably water-soluble, high-molecular-weight, organic compounds containing polar groups, such as polyvinylpyrrolidone, copolymers of vinyl propionate or acetate and vinylpyrrolidone, partially saponified copolymers of an acrylate and acrylonitrile, polyvinyl alcohols having various residual acetate contents, cellulose ethers, gelatine, block copolymers, modified starch, low-molecular-weight, carboxyl- and/or sulfonyl-containing polymers, or mixtures of these substances.

Particularly preferred protective colloids are polyvinyl alcohols having a residual acetate content of below 40 mol %, in particular from 5 to 39 mol %, and/or vinylpyrrolidone-vinyl propionate copolymers having a vinyl ester content of below 35% by weight, in particular from 5 to 30% by weight.

The desired property combinations of the nanoparticles required can be set in a targeted manner by adjustment of the reaction conditions, such as temperature, pressure and reaction duration. The corresponding setting of these parameters presents the person skilled in the art with absolutely no difficulties. For example, work can be carried out at atmospheric pressure and room temperature for many purposes.

In a preferred process variant, a second emulsion in which a reactant for the precursors is in emulsified form is mixed in step b) with the precursor emulsion from step a). This two-emulsion process allows the production of particles having a particularly narrow particle-size distribution. It may be particularly advantageous here for the two emulsions to be mixed with one another by the action of ultrasound.

In another, likewise preferred process variant, the precursor emulsion is mixed in step b) with a precipitant which is soluble in the continuous phase of the emulsion. The precipitation is then carried out by diffusion of the precipitant into the precursor-containing micelles. For example, titanium dioxide particles can be obtained by diffusion of pyridine into titanyl chloride-containing micelles or silver particles can be obtained by diffusion of long-chain aldehydes into silver nitrate-containing micelles.

The nanoparticles according to the invention are used, in particular, for UV protection in polymers. In this application, the particles either protect the polymers themselves against degradation by UV radiation, or the polymer composition comprising the nanoparticles is in turn employed—for example in the form of a protective film—as UV protection for other materials. The present invention therefore furthermore relates to the corresponding use of nanoparticles according to the invention for the UV stabilisation of polymers and UV-stabilised polymer compositions essentially consisting of at least one polymer which are characterised in that the polymer comprises nanoparticles according to the invention. Polymers into which the nanoparticles according to the invention can be incorporated well are, in particular, polycarbonate (PC), polyethylene terephthalate (PETP), polyimide (PI), polystyrene (PS), polymethyl methacrylate (PMMA) or copolymers comprising at least a fraction of one of the said polymers.

The incorporation can be carried out here by conventional methods for the preparation of polymer compositions. For example, the polymer material can be mixed with nanoparticles according to the invention, preferably in an extruder or compounder.

Depending on the polymer used, it is also possible to employ compounders.

A particular advantage of the particles according to the invention consists in that only a low energy input compared with the prior art is necessary for homogeneous distribution of the particles in the polymer.

The polymers here can also be dispersions of polymers, such as, for example, paints. The incorporation can be carried out here by conventional mixing operations.

The polymer compositions according to the invention comprising the nanoparticles are furthermore also particularly suitable for the coating of surfaces. This enables the surface or the material lying beneath the coating to be protected, for example, against UV radiation.

The following examples are intended to explain the invention in greater detail without limiting it.

### EXAMPLES

### Example 1

### Synthesis of the Macrosurfactants

The first step comprises the synthesis of a random copolymer of dodecyl methacrylate (lauryl methacrylate; LMA) and dimethylaminoethyl methacrylate (DMAEMA). Control of the molecular weight can be achieved by addition of mercaptoethanol. The copolymer obtained in this way is modified by means of 1,3-propane sultone in order to supply saturated groups.

To this end, 7 g of LMA and DMAEMA, in an amount corresponding to Table 1 below, are initially introduced in 12 g of toluene and subjected to free-radical polymerisation under argon at 70° C. after initiation of the reaction by addition of 0.033 g of AIBN in 1 ml of toluene. The chain growth can be controlled here by addition of 2-mercaptoethanol (see Table 1). The crude polymer is washed, freeze-dried and subsequently reacted with 1,3-propane sultone, as described in V. Butun, C. E. Bennett, M. Vamvakaki, A. B. Lowe, N. C. Billingham, S. P. Armes, J. Mater. Chem., 1997, 7(9), 1693-1695.

The characterisation of the resultant polymers is given in Table 1.

TABLE 1
Amounts of monomers employed and characterisation
of the resultant polymers

| | | DMAEMA | 1- | | | |
|---|---|---|---|---|---|---|
| | | in the | Mercapto- | | | Betaine |
| | DMAEMA | polymer | ethanol | Mₙ | M_{w} | groups |
| | [g] | [mol %] | [g] | [g/mol] | [g/mol] | [mol %] |
| E1 | 1.08 | 19 | 0.033 | 18000 | 31000 | 16 |
| E2 | 1.08 | 19 | 0.011 | 28000 | 51000 | 19 |
| E3 | 1.08 | 21 | 0.066 | 13000 | 21000 | 21 |
| E4 | 1.09 | 20 | — | 59000 | 158000 | 14.6 |
| E5 | 0.48 | 10.7 | — | 52000 | 162000 | 7.5 |

### Example 2

### Precipitation of ZnO Particles

ZnO particles are precipitated by the following method:
1. Preparation of in each case an inverse emulsion of an aqueous solution of 0.4 g of Zn(AcO)₂*2H₂O in 1.1 g of water (emulsion 1) and 0.15 g of NaOH in 1.35 g of water (emulsion 2) by means of ultrasound. Emulsion 1 and emulsion 2 each comprise 150 mg of a random copolymer E1-E5 from Table 1.
2. Ultrasound treatment of the mixture of emulsion 1 and emulsion 2 and subsequent drying.
3. Purification of sodium acetate by washing the resultant solid with water.
4. Drying and re-dispersal of the polymer functionalised on the surface by the emulsifier by stirring in toluene.

FT-IR spectroscopy and X-ray diffraction indicate the formation of ZnO. Furthermore, no reflections of sodium acetate are visible in the X-ray diagram.

Thus, Example 2 results in a product which consists of the synthesised macrosurfactant and zinc oxide particles.

| | Diameter [nm] | | Proportion of ZnO |
|---|---|---|---|
| Copolymer | (light scattering) | Variance [nm] | (wt-%) |
| E1 | 37 | 30 | 30.3 |
| E2 | 66 | 53 | 30.5 |
| E3 | 50 | 41 | 32 |

### Comparative Example 2a

### Use of the Emulsifier ABIL EM 90®

The procedure as described in Example 2 with the commercially available emulsifier ABIL EM 90® (cetyl dimethicone copolyol, Goldschmidt) instead of the random copolymer from Example 1 does not result in a stable emulsion. The particles obtained exhibit diameters of between 500 and 4000 nm.

### Example 3

### Polymer Composition

A dispersion of the particles from Example 2-E1 in PMMA lacquer is prepared by mixing, applied to glass substrates and dried. The ZnO content after drying is 10% by weight. The films exhibit a virtually imperceptible haze. Measurements using a UV-VIS spectrometer confirm this impression. The sample exhibits the following absorption values, depending on the layer thickness (the percentage of incident light lost in transmission is shown).

| Layer thickness | UV-A (350 nm) | VIS (400 nm) |
|---|---|---|
| 1.2 μm | 35% | 4% |
| 1.6 μm | 40% | 5% |
| 2.2 μm | 45% | 7% |

Comparison:

(ZnO (Extra Pure, Merck) in PMMA Lacquer as Above)

| | | |
|---|---|---|
| 2 μm | 64% | 46% |

1. Polymer-modified nanoparticles which are suitable as UV stabilisers in polymers, characterised in that they are obtainable by a process in which, in a step a), an inverse emulsion comprising one or more water-soluble precursors of the nanoparticles or a melt is prepared with the aid of a random copolymer of at least one monomer containing hydrophobic radicals and at least one monomer containing hydrophilic radicals, and, in a step b), particles are produced.

2. Nanoparticles according to claim 1, characterised in that the particles essentially consist of oxides or hydroxides of silicon, cerium, cobalt, chromium, nickel, zinc, titanium, iron, yttrium and/or zirconium.

3. Nanoparticles according to claim 1, characterised in that the particles have a mean particle size, determined by means of dynamic light scattering or transmission electron microscope, of from 3 to 200 nm, preferably from 20 to 80 nm, and very particularly preferably from 30 to 50 nm, and the particle-size distribution is preferably narrow.

4. Nanoparticles according to claim 1, characterised in that the absorption maximum is in the range 300-500 nm, preferably in the range up to 400 nm.

5. Process for the production of polymer-modified nanoparticles, characterised in that, in a step a), an inverse emulsion comprising one or more water-soluble precursors of the nanoparticles or a melt is prepared with the aid of a random copolymer of at least one monomer containing hydrophobic radicals and at least one monomer containing hydrophilic radicals, and, in a step b), particles are produced.

6. Process according to claim 5, characterised in that particles are produced in step b) by reaction of the precursors or by cooling of the melt.

7. Process according to claim 6, characterised in that the precursors are reacted with an acid, a base, a reducing agent or an oxidant.

8. Process according to claim 1, characterised in that the droplet size in the emulsion is in the range from 5 to 500 nm, preferably in the range from 10 to 200 nm.

9. Process according to claim 1, characterised in that a second emulsion in which a reactant for the precursors is in emulsified form is mixed in step b) with the precursor emulsion from step a).

10. Process according to claim 9, characterised in that the two emulsions are mixed with one another by the action of ultrasound.

11. Process according to claim 1, characterised in that the one or more precursors are selected from water-soluble metal compounds, preferably silicon, cerium, cobalt, chromium, nickel, zinc, titanium, iron, yttrium or zirconium compounds, and the precursors are preferably reacted with an acid or lye.

12. Process according to claim 1, characterised in that a coemulsifier, preferably a nonionic surfactant, is employed.

13. Process according to claim 1, characterised in that the weight ratio of structural units containing hydrophobic radicals to structural units containing hydrophilic radicals in the random copolymers is in the range from 1:2 to 500:1, preferably in the range from 1:1 to 100:1 and particularly preferably in the range from 7:3 to 10:1, and the weight average molecular weight of the random copolymers is in the range from M_{w}=1000 to 1,000,000 g/mol, preferably in the range from 1500 to 100,000 g/mol and particularly preferably in the range from 2000 to 40,000 g/mol.

14. Process according to claim 1, characterised in that the copolymers conform to the formula I 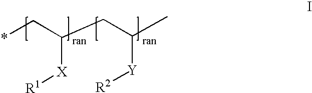
where
X and Y correspond to the radicals of conventional nonionic or ionic monomers, and
R¹ stands for hydrogen or a hydrophobic side group, preferably selected from branched or unbranched alkyl radicals having at least 4 carbon atoms, in which one or more, preferably all, H atoms may have been replaced by fluorine atoms, and
R² stands for a hydrophilic side group, which preferably has a phosphonate, sulfonate, polyol or polyether radical,
and where —X—R¹ and —Y—R² may each have a plurality of different meanings within a molecule.

15. Process according to claim 14, characterised in that X and Y, independently of one another, stand for —O—, —C(═O)—O—, —C(═O)—NH—, —(CH₂)ₙ—, phenylene or pyridyl.

16. Process according to claim 1, characterised in that at least one structural unit contains at least one quaternary nitrogen atom, where R² preferably stands for a —(CH₂)ₘ—(N⁺(CH₃)₂)—(CH₂)ₙ—SO₃⁻ side group or a —(CH₂)ₘ—(N⁺(CH₃)₂)—(CH₂)ₙ—PO₃²⁻ side group, where m stands for an integer from the range from 1 to 30, preferably from the range from 1 to 6, particularly preferably 2, and n stands for an integer from the range from 1 to 30, preferably from the range from 1 to 8, particularly preferably 3.

17. Process according to claim 1, characterised in that at least one structural unit is an oligomer or polymer, preferably a macromonomer, where polyethers, polyolefins and polyacrylates are particularly preferred as macromonomers.

18. Use of nanoparticles according to claim 1 for the UV stabilisation of polymers.

19. UV-stabilised polymer composition essentially consisting of at least one polymer, characterised in that the polymer comprises nanoparticles according to claim 1.

20. Polymer according to claim 19, characterised in that the polymer is polycarbonate (PC), polyethylene terephthalate (PETP), polyimide (PI), polystyrene (PS), polymethyl methacrylate (PMMA) or a copolymer having at least a fraction of one of the said polymers.

21. Process for the preparation of UV-stabilised polymer compositions, characterised in that the polymer material is mixed with nanoparticles according to claim 1, preferably in an extruder or compounder.
